(19) United States
(12) Patent Application Publication
(10) Pub. No.: US 2009/0271858 A1
(43) Pub. Date: Oct. 29, 2009

(54) Method For Connecting Unclassified And Classified Information Systems

(75) Inventors: Jeffrey Lynn Cooke, Manassas, VA (US); Thomas M. Staples, Gainesville, VA (US); Paul A. Schmidt, Front Royal, VA (US); Vincent Hayvord Fleming, SR., Manassas, VA (US); Julia Walsh, Manassas, VA (US)

Correspondence Address: Lockheed Martin c/o;DEMONT & BREYER, LLC, 100 COMMONS WAY, Ste. 250, HOLMDEL, NJ, 07733, US

(73) Assignee: Lockheed Martin Corporation, Bethesda, MD (US)

(21) Appl. No.: 12/430,647

(22) Filed: Apr. 27, 2009

Related U.S. Application Data
(60) Provisional application No. 61/047,932, filed on Apr. 25, 2008.

(51) Int. Cl. G06F 15/16; G06F 17/00

(52) U.S. Cl. 726/12

(57) ABSTRACT

A method and system that enables the connection of an unclassified information system to a classified information system while meeting all government requirements. The system utilizes a combination of COTS technologies (e.g., a Trusted Gateway System, type-2 encryption software, etc.), local administrative policies, and scriptable software applications.

### STATEMENT OF RELATED CASES

This case claims priority of U.S. Provisional Patent Application Ser. No. 61/047,932, which is incorporated herein by reference.

### FIELD OF THE INVENTION

The present invention relates to the handling of unclassified and classified software during development.

### BACKGROUND OF THE INVENTION

Branches of the U.S. military, such as the Department of Navy (DoN), regularly work with the private sector on various programs. These programs often involve software development. In many cases, software developers can design the software so that it can be reused. Reusing software on later versions of a program or across multiple (different) programs can greatly reduce development and maintenance costs for the DoN.

Currently, the reuse potential of software is limited. For classified programs, removing software from that program's classified security domain can be very difficult or even prohibited by the program's Security Classification Guide. In many circumstances, the software inside the classified security domain is actually unclassified. Often, software developers design the software in such a manner as to segregate the unclassified software from the classified software. Yet, due to the policy constraints in moving ANY software outside of the classified network, all software reuse is generally limited to the program itself.

System testing of software on classified systems typically occurs in the program's classified computer lab. This is a consequence, primarily, of two considerations. First, the system test lab might be the only place where all system components are integrated and tested as a system. Second, the system test lab often contains unique hardware or other components that are classified and cannot be located (or simulated) outside of the program's classified security domain.

The system test lab introduces yet another problem. During software testing, test engineers often identify faults in the software that must be corrected. There are usually schedule constraints that both the test engineers and the software developers operate under; the software faults therefore need to be corrected quickly and efficiently. This has generally been additional rationale for the management of unclassified software in the classified environment.

In summary, a company's (or the DoN's) desire to reuse the unclassified components of a classified software program is greatly inhibited by: (1) the policies of the program's classified security domain and (2) the need for rapid resolution of software faults in the test environment.

### SUMMARY OF THE INVENTION

The present invention provides a way to securely and effectively enable unclassified software components to be developed in a separate, unclassified development environment and transferred into any classified program (secure) computer lab for integration and test.

The present inventors recognized that to extent unclassified software is difficult to remove from the classified security domain, it would be better not to generate unclassified software in the classified security domain. Rather, unclassified software should be created and maintained in the unclassified security domain. This permits an unclassified development environment to “feed” many classified development environments, potentially reducing the required size of each classified environment. This is important since the cost of maintaining a classified development environment is proportional to its size.

It became clear to the inventors that such a system would provide a potential for substantial cost savings. But to realize this potential, the system must include a mechanism to allow near real-time transfer of these components into the classified program integration and test environments. This is required, for example, for rapid problem resolution to meet tight program delivery schedules.

In accordance with the illustrative embodiment, a protected and secure one-way information path is provided from a set of users in an unclassified development environment to a set of users in a classified program computer lab. The way this path is implemented is via a multi-level security device (commonly known as a High Assurance Guard or “HAG”) along with trusted Network File System (NFS) channels, enforced policies on the mounting point that limit access to the information path, and access control policies that limit the developers that can access the one-way information path. Additional software is also necessary to insure the file transfers are quick and automated.

### BRIEF DESCRIPTION OF THE DRAWINGS

FIG. 1 depicts a development environment in accordance with the illustrative embodiment of the present invention, wherein the development environment includes both a classified and an unclassified region as well as an interface between those regions.

FIG. 2 depicts method 200 for transferring a file from an unclassified development environment to a classified development environment.

FIG. 3 depicts subtasks for accomplishing task 202 of method 200.

FIG. 4 depicts subtasks for accomplishing task 204 of method 200.

### DETAILED DESCRIPTION

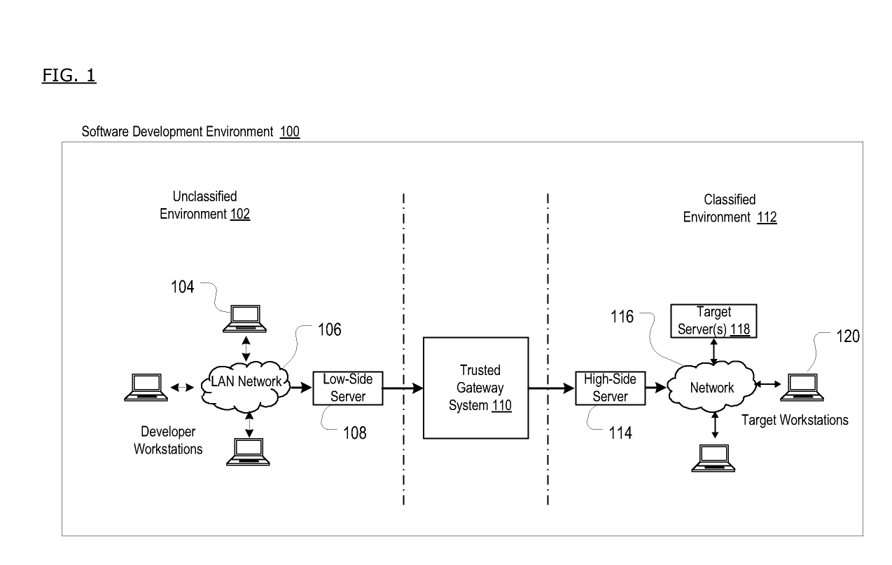

FIG. 1 depicts software development environment 100 in accordance with the illustrative embodiment of the invention. Environment 100 includes an unclassified development environment 102 and a classified development environment 112. The unclassified development environment includes a plurality of developer workstations (e.g., laptops, workstations, etc.) 104, which are networked through local area network 106. Environment 102 also includes low-side server 108. Classified development environment 112 includes high-side server 114, one or more target servers 118 and a plurality of workstations 120, which are connected through network 116. Low-side server 108 and high-side server 114 are discussed in further detail in conjunction with the discussion of FIG. 3.

Development environment 100 also includes Trusted Gateway System (TGS) 110. The TGS is a multi-level security device that fulfills the requirements of a High Assurance Guard in the illustrative embodiment. Other commercial devices having similar functionality to the TGS can be used in some other embodiments. In the illustrative embodiment, TGS 110 is configured for one-way transfer, which provides secure and reliable transfer of unclassified software products from developer workstations 104 to target servers 118 in classified environment 112, such as for integration and test. Typically, environment 100 includes a low-side (unclassified) server and a high-side (classified) server.

The TGS is available from Trusted Computer Solutions of Herndon, Va. TGS was designed to meet and exceed the requirements for a Protection Level 4 (PL4) system specified by the Director of Central Intelligence Directive 6/3 (DCID 6/3) and Department of Defense (DoD) Information Assurance Certification and Accreditation Program (DIACAP). The technical design is based on secure systems engineering practices and trusted operating system security enforcement at the server level. The TGS employs a trusted operating system, “Trusted Solaris®,” as its primary mechanism for security policy enforcement.

In the illustrative embodiment, the TGS is hosted on Sun Microsystems® Trusted Solaris® operating environment which includes role-based administration, mandatory access controls, use of least privilege and removal of the super-user root account. Trusted Solaris 8 4/01 is a UNIX-based operating system which can be configured from a number of workstations and servers to form a single distributed system. It meets the requirements for secure computing, including ‘Multi-Level’ and ‘System High’ operation.

The TGS supplements features that are integral to Trusted Solaris 8 by providing additional security safeguards, including embedded virus scanning and advanced kernel-level Internet Protocol packet filtering. The system implements a heterogeneous virus scanner that simultaneously scans for UNIX, Amiga®, Macintosh®, Windows 95/NT® and MS-DOS® viruses that perform denial-of-service and back-door attacks, plus hostile Java applications and applets and OLE/VB5 macro viruses. The TGS automatically transfers, to a pre-designated high-side server, any files determined to be free of viruses. All transfers are performed using “Trusted NFS.” The system scans files for viruses as each file is transferred from one level to the other. The TGS automatically deletes any virus-laden file, whether it is embedded in an executable file or as a macro in a Microsoft Office® product. It enforces site security policies using a configurable security policy through varied security features and filters.

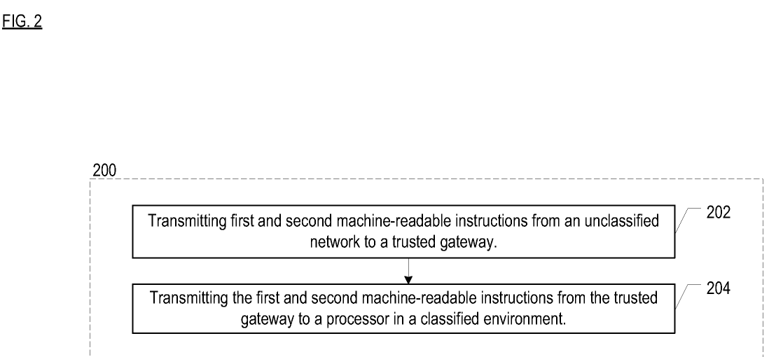

As previously indicated, the flow of information from unclassified development environment 102 through TGS 110 and into classified environment 112 is one-way, which presents a usability issue. Modern computer systems typically provide users with explicit feedback of success or failure for basic operations such as file transfer operations. In this environment, there can be no such feedback. TGS 110 cannot and will not allow information to flow from the classified environment to the unclassified environment, even if that information is the success or failure of file movement. Method 200, depicted in FIG. 2 and described below, enables a user to effectively deal with the challenges that arise in this environment.

FIG. 2 depicts method 200 in accordance with the illustrative embodiment of the present invention. The method recites the following tasks:
Task 202: transmitting, from an unclassified network operating in an unclassified environment to a trusted gateway:
   (1) first machine-readable instructions to be executed on a processor in a classified network operating in a classified environment, and
   (2) second machine-readable instructions that direct how the first machine-readable instructions are to be prepared for execution on the processor; and
Task 204: transmitting, from the trusted gateway to the processor in the classified environment:

(1) the first machine-readable instructions, and

(2) the second machine-readable instructions.

The method begins, for example, when a user (e.g., software developer, etc.) wishes to transfer one or more files comprising first machine-readable instructions (e.g., source code, object code, or intermediate code, etc.) from an unclassified environment to a classified (secure) environment (e.g., for debugging, testing, etc.).

In accordance with the illustrative embodiment, method 200 can only be initiated by users who are cleared, have a need to know, and are authorized to work on a particular (classified) program. This is enforced, for example, by restricting user accounts on the unclassified side to only that set of cleared users authorized to work the selected programs with accounts on the classified side. A valid user account is necessary to successfully transfer files to the low-side server in preparation for transfer. This policy is used to ensure: (1) only cleared personnel have access to the classified program computer labs and (2) those personnel have active accounts. This ensures that users pull their own data from the unclassified development environment into the classified environment.

In the illustrative embodiment, task 202 comprises subtasks 302 through 306, which are depicted in FIG. 3, and task 204 comprises subtasks 402 through 408.

In accordance with subtask 302, files that are to be transferred are associated with the second machine-readable instructions, which in the illustrative embodiment is a “script.” A script is a list of commands that can be executed without user interaction. Being accessible to the end-user, scripts enable the behavior of an application to be adapted to a user's needs. Scripts are often, but not always, interpreted from the source code unlike the applications they are associated with, which are traditionally compiled to native machine code for the system on which they run.

The script creates a meta-data file that captures information about the user and information that enables the first machine-readable instructions to be transferred (in the illustrative embodiment, to an associated configuration management directory on the classified side). In the illustrative embodiment, the script builds an inventory of the file set and then bundles the inventory and the file set into a single “Archive” file. The term “Archive file” is being used herein in a generic sense to refer to a collection of files and meta data. It can be implemented as a zip file, etc.

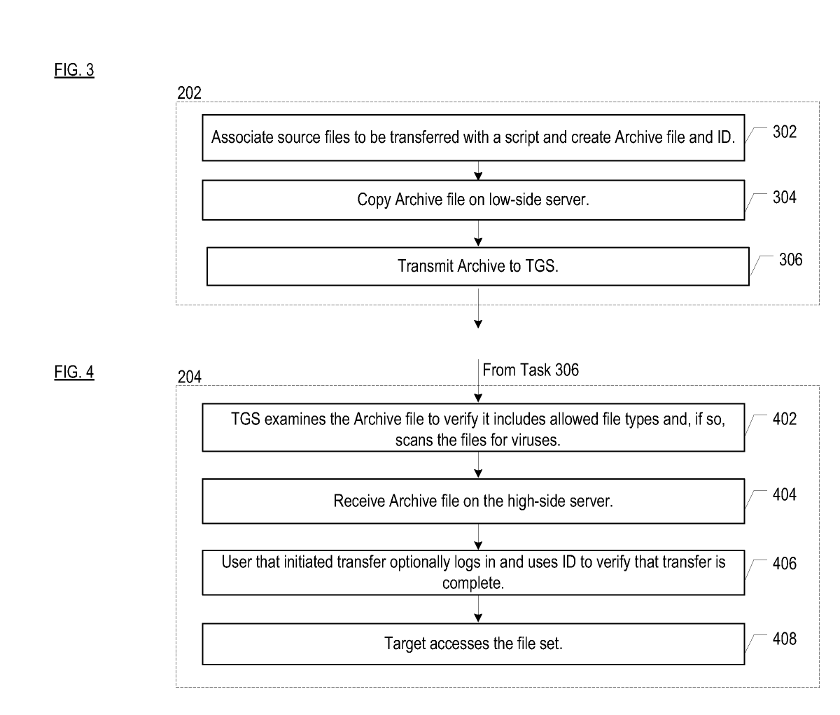

During creation of the Archive, the script creates a unique identifier (ID) and provides the ID to the unclassified development environment user. Using this ID, the user can be assured that the Archive file that is transferred to the high side contains the same file set as that designated for transfer (see optional task 406 of FIG. 4).

In accordance with subtask 304, the script then connects to low-side server 108 and copies the Archive file onto the low-side server. The connection is effected via a network protocol, such as SSH, that enables data to be exchanged using a secure channel between two networked devices. In the illustrative embodiment, the low-side server has previously exported the file system via NFS to TGS 110.

In accordance with subtask 306, the Archive is transmitted to TGS 110. More particularly, a “File Available” process running on TGS 110 monitors the contents of low-side server file system at regular intervals looking for incoming files. When a file is found, the File Available process hands off the file to a “File Processing” process, which is described below under the discussion of the subtasks of task 204.

In accordance with subtask 402 of task 204, the TGS runs the File Processing process. The File Processing process has several functions. One function is to determine file type. This is accomplished by decomposing the Archive file using, for example, UAD and Libmagic. For composite files (e.g., tarballs, etc.), the file type is determined for each component within the file. When all components are within the set of allowed types (an all or nothing decision) and allowed extensions (an all or nothing decision), processing continues. When not, the file is deleted and a log entry made, audit event recorded and/or email alert sent. In the illustrative embodiment, no files are quarantined.

A second function is to scan the files for viruses. In some embodiments, TGS 110 is configured to set a list of specific scanning exceptions for each component. Virus scanning of file content is performed when all components are specified for scanning (none are exceptions). When all components are found to be free of viruses, processing continues. When not, the file is deleted and a log entry made, audit event recorded and/or email alert sent. Files are not quarantined.

After the File Processing process is complete, a “Transfer File” process takes the file (i.e., the first machine-readable instructions) and moves it to a new directory within the same file system to reduce physical data moves. In the illustrative embodiment, the transfer utilizes intermediate MAC compartment to protect the file without upgrading to High. This is a one-way transfer with the High side restricted using, for example, Trusted Solaris® to enforce write up/read down.

In task 404, the first machine-readable instructions become available on the high-side server (in the illustrative embodiment, under a specific file system NFS mounted to the TGS using “Trusted NFS”). Accesses to the NFS server is controlled through SecureOffice eFilter and restricted by the MAC and DAC mechanisms of Trusted NFS. Users on classified network 116 have read access to the file. This action is accomplished using scripts that use the meta data file with information about the user and files to transfer the files to the configuration management directory or users home directory on the High side. The script unbundles the file set with the inventory, moves them into a holding area for the identified user, and logs the successful transfer.

As per optional task 406, the user that initiated the transfer to the classified environment can log in on the classified side, authenticate, and check the script log for his/her ID to confirm the transfer has completed. In this manner, the user can know the file has been successfully transferred without contacting the administrators.

In task 408, the first machine-readable code is copied onto the workstations in classified environment 112 for access. It is notable that in the illustrative embodiment, the Archive file is copied and expanded onto server(s) 118. Developers on the classified side use workstations 120 to access the information stored on server(s) 118.

In illustrative system and method satisfies the NISPOM definition of a controlled interface (8-701). This is accomplished by using the Solaris™ Trusted Operating System built-in policy enforcement model that ensures Mandatory Access Controls (MAC) are implemented on all files and devices (e.g., network interface). Enforcement of MAC is performed by the operating system kernel without the ability to bypass its security model implementation—derived from the Bell LaPadula security model to only allow “read-down” and “write-up” security level dominance operations.

The TGS system works within the boundary of the OS security model (without violation of data confidentiality and integrity) to segregate data (based on data security level) into distinct domains that require a trusted process (i.e., TGS daemon—“tgsmonitor”) to perform cross-domain interoperability functions. The TGS system and the underlying operating system adheres to the protection level profiles established for labeled security, role-based access controls and controlled access.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A system comprising:
an unclassified network operating in an unclassified environment that comprises unclassified information that comprises:
(1) first machine-readable instructions to be executed on a processor, and
(2) second machine-readable instructions that direct how the first machine-readable instructions are to be prepared for execution on the processor;
a classified network operating in a classified environment that comprises the processor; and
a trusted gateway for one-way transfer of the first machine-readable instructions and the second machine-readable instructions from the unclassified network to the processor in the classified network.

2. The system of claim 1 further comprising a low-side server, the first machine-readable instructions and the second machine-readable instructions are transmitted to the low-side server.

3. The system of claim 2 wherein the trusted gateway is further capable of monitoring for the low-side server for the first machine-readable instructions.

4. The system of claim 1 wherein the second machine-readable instructions generate a meta-data file comprising information pertaining to a user who wishes to transfer the first machine-readable instructions.

5. The system of claim 1 wherein the second machine-readable instructions generate a meta-data file comprising information pertaining to how to transfer the first machine-readable instructions.

6. The system of claim 4 wherein the second machine-readable instructions generate an archive file comprising:
(a) an inventory of files associated with how to transfer the first machine-readable instructions to the processor; and
(b) the first machine-readable instructions.

7. The system of claim 1 wherein the second machine-readable instructions generate a unique identifier for a user who wishes to transfer the first machine-readable instructions, wherein the unique identifier is used to validate transfer to the classified environment.

8. A method comprising:
transmitting, from an unclassified network operating in an unclassified environment to a trusted gateway:
(1) first machine-readable instructions to be executed on a processor in a classified network operating in a classified environment, and
(2) second machine-readable instructions that direct how the first machine-readable instructions are to be prepared for execution on the processor; and
transmitting, from the trusted gateway to the processor in the classified environment:
(1) the first machine-readable instructions, and
(2) the second machine-readable instructions.

9. The method of claim 8 wherein after the first machine-readable instructions and the second machine-readable instructions are transmitted to the trusted gateway, the method further comprises verifying, at the trusted gateway, that the first machine-readable instructions are within an allowed set of files to be transferred to the classified environment.

10. The method of claim 8 wherein after the first machine-readable instructions and the second machine-readable instructions are transmitted to the trusted gateway, the method further comprises verifying that the first machine-readable instructions and the second machine-readable instructions are free of viruses.
